(19) United States
(12) Patent Application Publication
(10) Pub. No.: US 2012/0188642 A1
(43) Pub. Date: Jul. 26, 2012

(54) SAFETY ELEMENT FOR VEHICLES

(76) Inventor: Vladimir Cejka, Pecky (CZ)

(21) Appl. No.: 13/351,353

(22) Filed: Jan. 17, 2012

(30) Foreign Application Priority Data
Jan. 24, 2011 (CZ) PUV 2011-23828

(51) Int. Cl. G02B 7/182

(52) U.S. Cl. 359/549

(57) ABSTRACT

A safety element for vehicles includes a magnetic layer and a reflective layer attached to the magnetic layer.

### BACKGROUND AND SUMMARY

The present invention relates to safety elements for vehicles such as cars.

Presently, standard reflecting glass (or plastic) elements are typically used as safety elements for cars. They are fixed by the car producer at a rear part of the car and are made as an integral part of the car's light. A disadvantage of the reflecting glass element is the potential reduction of its reflectivity, i.e. efficiency and reflectivity because of possible pollution with dust, dirtiness, snow or ice, this because it is permanently exposed to unfavourable climate conditions. The reflecting glass elements are, at the same time, vulnerable regarding damage by collision. Another disadvantage is that, in the event of a collision or other traffic accident, these fixed reflecting glass elements may not always be placed in the direction from where other cars arrive and therefore such car, which might be a barrier for traffic, such as if it extends across a road, may be easily overlooked, particularly in road sections without lighting, which might result in an accident, i.e. a traffic accident involving other cars, damage of property and/or loss of health or life. The same applies also to the so called parking or warning lights when the lights might not be fully operating in the case of a traffic accident or crash of the car and/or sufficiently turned to the direction from where other participants of the road traffic arrive which may again result in collision of the cars.

Another form of safety element is the warning triangle that, in the event of an accident, is assembled and placed the appropriate distance from the car as provided by legislation. For example, some legislation requires that the triangle, when used on a highway, be located at least 100 meters behind the car, which might be, provided an average speed of a walking person, a period of 80 seconds. During this time, the car is unprotected before the triangle is assembled and placed at the appropriate distance from the car. Only after that time, the obligatory warning triangle is fully functional. The mentioned time is critical and it can also result in collision of cars under this reduced visibility. Another fact is that the triangle placed behind the car may be tumbled and destroyed by another car, by which it no more plays its warning and reflecting function and there is no other adequate substitution. There are also situations when the crashed or damaged car remains across the road and crosses two lanes. The warning triangle in that case informs drivers only from one direction, but not from the other direction. Besides, the folding warning triangle is most often placed in the boot of the car and when the boot is damaged or deformed, it might not be always accessible and again there is no other adequate substitution.

Another issue is dragging of a damaged car. At present, there is no product on the market which would in a suitable manner inform other participants of road traffic about the fact that the car in front of them is dragged because of a defect. Use of warning interrupted lights is not suitable and even not recommended because other participants of road traffic lose the information about when and where the dragged car will change its direction.

In an aspect of the present invention, a safety element for vehicles comprises a magnetic flexible bedding provided with a highly flexible foil with a warning sign which can be repeatedly fixed to the car body.

The safety element with advantage is in the shape of the warning triangle. The highly reflective flexible foil is in the advantageous design in red and/or yellow and/or orange and/or white colour in usual and/or fluorescent design.

The safety element—reflective element is produced from a usually available magnetic flexible foil and highly reflective flexible foil with a layer of red, yellow, orange or white colour in usual and/or fluorescent, design. The fluorescent design increases visibility even in daylight. These two materials are fixed to each other with an adhesive and/or by thermal melting. The shape is with advantage triangle—usual sign of danger. The size, shape and weight allow placing of the magnetic reflective triangle in the door box next to the driver, into the shelf box in front of the co-driver or in another suitable place, while it is always ready for use. The reflective magnetic triangle is immediately functional. The time delay between the accident and installation of this product is therefore minimal and covers the time until installation of the obligatory folding warning triangle.

An advantage of this reflective magnetic triangle is the fact that it is highly reflective, it resists dirtiness, moisture and wind, it is light and flexible; its functionality is independent on the power supply and the scope of the car damage. No tools and implements are needed for its installation. It is not necessary to unfold it like in the case of the standard obligatory triangle. The bottom magnetic flexible layer is adhesive enough to adhere to the car body, to partly adjust to it and stay fixed until its subsequent removal. The magnetic layer need not adhere to the car body with its entire surface; fifty per cent of its contact surface is enough to fix it in place.

The safety element contributes to an improved safety of road traffic by the fact that reflection of the light warns under reduced visibility other drivers about the place where is a possible barrier of road. traffic, while this product does not depend on the scope of the car damage, power supply or location of the car on the road like is the case of standard reflective glass elements place on the rear part of the car. The product is suitable both for new, and for older cars and other motor vehicles. Installation of the product is very quick and simple, without using of tools and implements, it efficiency is high, immediate, unlimited in time and its installation can be repeated. The product does not damage the car body and surface. The product can be used also when a car is drugged when its placing on the rear part of the dragged car gives clear information to cars behind it that the car is drugged. Based on that, other drivers can respond adequately, adjust their speed or increase the distance from the dragged car, with a similar effect like in the case of labels informing that the car is driven by a driver-beginner.

### BRIEF DESCRIPTION OF THE DRAWINGS

The features and advantages of the present invention are well understood by reading the following detailed description in conjunction with the drawings in which like numerals indicate similar elements and in which:

FIG. 1 is a schematic, perspective view of a safety element according to an aspect of the present invention;

FIG. 2 is a schematic side view of a car with a plurality of safety elements according to aspects of the present invention attached thereto; and

FIG. 3 is a schematic, perspective view of a safety element according to an aspect of the present invention.

### DETAILED DESCRIPTION

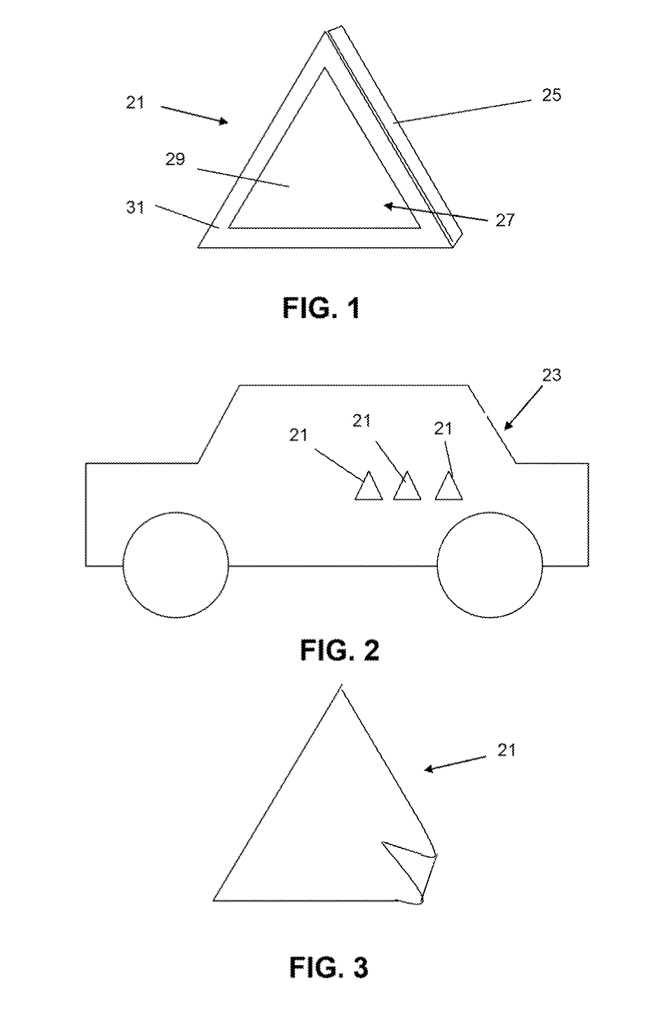

FIG. 1 shows a safety element 21 for cars 23 (FIG. 2) that consists of or comprises a magnetic flexible bedding 25 provided with reflective flexible foil 27. The safety element 21 can be in the form of a warning sign in any suitable shape, preferably in the shape of a warning triangle, and in any suitable color or combination of colors, for example, red and/or white colors, such as an inner color 29 and an outer color 31. Corners of the shape may be more rounded than illustrated. Several separate safety elements can be provided and can be fixed to the car body several times in different locations as seen in FIG. 2.

As seen in FIG. 3, the safety element 21 can be flexible and may in the form of a reflective element produced from a magnetic bedding 25 in the form of a magnetic flexible foil layer and a flexible foil 27 in the form of highly reflective flexible foil layer. The foil layer may be red, yellow, and/or white, or combinations of these colors, in fluorescent design. These two materials are fixed to each other by any suitable means, such as a durable adhesive. The shape can be any suitable shape, preferably a triangle. The size, shape and weight allow placing of the magnetic reflective triangle in the door box next to the drive, into the shelf box in front of the co-driver or in another suitable place, so that it is conveniently accessible and ready for use.

When an accident, crash or defect of the car occurs, the driver can take the triangle when getting out of the car and place it in a suitable place on the metal car body. The driver can position the safety element appropriately so that it is visible by others approaching the vehicle. The reflective magnetic triangle is, thus, functional immediately. The time delay between the accident and installation of the product is minimal and it therefore covers the time until installation of the obligatory folding warning triangle.

The safety element according to this technical solution can be used namely for motor vehicles for their lighting with the use of reflected light from other motor vehicles, this under dusk, dark or reduced visibility in the case of traffic accident, crash or defect of a vehicle.

1. A safety element for vehicles, comprising:
a magnetic layer; and
a reflective layer attached to the magnetic layer.

2. The safety element as set forth in claim 1, wherein the reflective layer comprises a reflective foil material.

3. The safety element as set forth in claim 1, wherein the magnetic layer and the reflective layer are flexible.

4. The safety element as set forth in claim 3, wherein the safety element is flexible.

5. The safety element as set forth in claim 1, wherein the safety element is triangular.

6. The safety element according to claim 1, wherein the safety element is fluorescent.
